(19) United States
(12) Patent Application Publication
(10) Pub. No.: US 2026/0254910 A1
(43) Pub. Date: Aug. 27, 2026

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Yusuke ONO, Kanagawa (JP)

(73) Assignee: FUJIFILM Business Innovation Corp., Tokyo (JP)

(21) Appl. No.: 19/312,639

(22) Filed: Aug. 28, 2025

(30) Foreign Application Priority Data
Feb. 26, 2025 (JP) 2025-029319

(51) Int. Cl. H04N 1/23; H04N 1/00

(52) U.S. Cl. CPC H04N 1/2338; H04N 1/00411; H04N 1/233; H04N 1/2369; H04N 1/2392; H04N 2201/0094

(57) ABSTRACT

An information processing system includes a processor configured to execute, when a plurality of processes including a print process are to be executed on a recording medium by using image data that is unprocessed data that has not yet undergone an image process and has not yet been compressed and when the plurality of processes are to be executed with no order of execution individually designated, the print process before the other processes.

### CROSS-REFERENCE TO RELATED APPLICATIONS

This application is based on and claims priority under 35 USC 119 from Japanese Patent Application No. 2025-029319 filed February 26, 2025.

### BACKGROUND

### Technical Field

The present disclosure relates to an information processing system and a non-transitory computer readable medium.

### Related Art

Japanese Unexamined Patent Application Publication No. 2006-244249 discloses that, in a computer terminal and an image forming apparatus that are coupled to a network, the computer terminal includes: a print data conversion means for converting a document that the computer terminal handles into data that the image forming apparatus prints; and a transmission means for transmitting the print data that the conversion means has converted to the image forming apparatus via the network, and the image forming apparatus includes: a reception means for receiving the print data that the transmission means has transmitted; an expansion means for expanding the print data that the reception means has received into an image in a plurality of color spaces that differ from each other in color space; an accumulation means for accumulating the image that the expansion means has expanded in the image forming apparatus; an operation instruction means for instructing printing of the image that the accumulation means has caused to be accumulated or converting of a file format; a print means for printing the image that the operation instruction means has instructed; and a means for converting the image that the operation instruction means has instructed into another file format, and an image forming apparatus system includes: a means for selecting, when the computer terminal generates print data, immediately after the expansion means has performed expansion into an image, an output destination for printing in the image forming apparatus or accumulating in the image forming apparatus; and a means for transmitting information about the selected output destination together with the print data to the expansion means, determining whether the selected output destination corresponds to printing in the image forming apparatus or accumulating in the image forming apparatus based on the information about the selected output destination in the expansion means, and switching the color spaces for the image to be expanded in accordance with the determined output destination.

Japanese Unexamined Patent Application Publication No. 2003-333266 discloses an image input-and-output device that includes: an input means for inputting image data; a means for generating a unique image data ID for the inputted image data; a conversion means for converting the image data inputted via the input means into image data having a predetermined resolution; a conversion means for converting the image data that the conversion means has converted in resolution into a predetermined format; a storage means for storing the converted image data with the image data ID added; and a means for transmitting the converted image data, and that records a plurality of images having resolutions that differ from each other in the device.

### SUMMARY

For example, a piece of image data of a document that a scanner unit that an image forming apparatus includes reads is a piece of data that has undergone no process and has not yet been compressed (referred to as a piece of "RAW data").

In the image forming apparatus, a corresponding data format is designated for each process for a function that a user utilizes, and the data format of a piece of data, which corresponds to each process, is converted from the piece of RAW data. Therefore, when an identical piece of RAW data is used to execute processes for a plurality of functions, it is preferable to store the piece of RAW data as is in a storage device in the image forming apparatus.

However, a piece of RAW data may increase in data volume, compared with a piece of compressed data. To achieve a reduction in product cost in a low-end type image forming apparatuses, there is a tendency that a storage device that is smaller in storage capacity than a storage device used in a high-end type image forming apparatuses is used. Therefore, in the low-end type image forming apparatus, in particular, such a situation may occur that it is impossible to store pieces of RAW data of all documents in the storage device.

Due to such reasons as described above, such a situation may occur that a piece of RAW data has to be converted into a data format supporting a certain function among a plurality of functions before the piece of RAW data is stored in the storage device.

If the user executes a plurality of processes including printing and the image forming apparatus executes the printing last, the user has to wait around the image forming apparatus until the printing ends to pick up a printed document.

In addition, it is required to convert again the data format of the piece of data, which has been adapted to a process other than printing, into the piece of RAW data, and then perform conversion into a data format adapted to printing. Therefore, a waiting period of time for the user further extends longer.

Aspects of non-limiting embodiments of the present disclosure relate to provision of an image processing system and an image processing program capable of reducing a waiting period of time for a user waiting around an image forming apparatus in a situation where the user instructs the image forming apparatus to perform a plurality of processes including printing without individually designating an order of the processes, compared with a case where the image forming apparatus performs printing last.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor configured to execute, when a plurality of processes including a print process are to be executed on a recording medium by using image data that is unprocessed data that has not yet undergone an image process and has not yet been compressed and when the plurality of processes are to be executed with no order of execution individually designated, the print process before the other processes.

### BRIEF DESCRIPTION OF THE DRAWINGS

An exemplary embodiment of the present disclosure will be described in detail based on the following figures, wherein:

FIG. 1 is a diagram illustrating a functional configuration example of an image forming apparatus;

FIG. 2 is a diagram illustrating a configuration example of a main part in an electrical system in the image forming apparatus;

FIG. 3 is a flowchart illustrating an example of a flow of an execution process for a multi-job flow;

FIG. 4 is a flowchart illustrating an example of a flow of a completion time priority process; and

FIG. 5 is a flowchart illustrating an example of a flow of a multi-document process.

### DETAILED DESCRIPTION

Hereinafter, an exemplary embodiment will be described with reference to the accompanying drawings. Note that identical reference signs are applied to identical components and identical processes throughout the drawings, and overlapping description will be omitted. Dimensional ratios in the drawings are exaggerated for convenience of description and may differ from actual ratios.

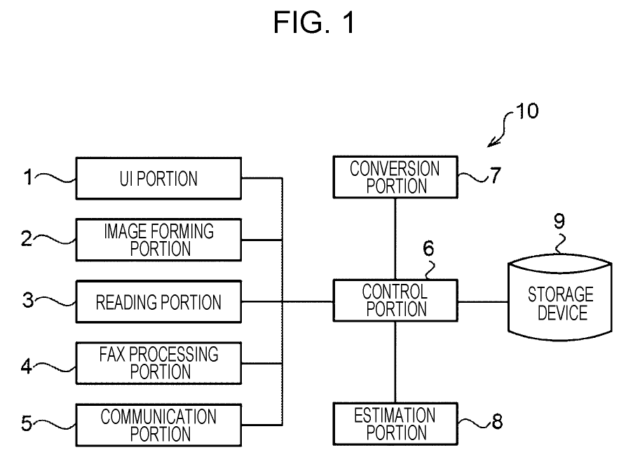

FIG. 1 is a diagram illustrating a functional configuration example of an image forming apparatus 10 serving as an example of an information processing system according to the present disclosure.

The image forming apparatus 10 forms an image that a piece of print data represents on a recording medium such as a sheet. Hereinafter, a function and a process of forming an image that a piece of print data represents on a recording medium are referred to as a "print function" and a "print process", respectively. The print process is an example of a print process according to the present disclosure. Additionally, forming an image that a piece of print data represents on a recording medium is referred to as a "print output". The image forming apparatus 10 includes at least another function in addition to the print function. Although there is no particular limitation in type of another function that the image forming apparatus 10 includes, the image forming apparatus 10 according to the present disclosure includes, as an example, a scan data transmission function and a facsimile function.

The scan data transmission function is a function of transmitting a piece of scan data representing content of a document that a scanner unit optically reads to an external device that a user designates. A process that the scan data transmission function executes is referred to as a "scan data transmission process". A document is a recording medium on which information that, for example, a diagram, a photograph, or text, represents is recorded.

The facsimile function is a function of transmitting and receiving a piece of data in accordance with a facsimile standard such as G3 or G4. For example, the image forming apparatus 10 transmits a piece of data that the user designates to a facsimile number that the user designates. Hereinafter, the facsimile function is simply referred to as "fax function". Therefore, a process that the fax function executes is referred to as a "fax process".

The image forming apparatus 10 including the plurality of functions described above includes functional portions including a user interface (UI) portion 1, an image forming portion 2, a reading portion 3, a fax processing portion 4, and a communication portion 5. Furthermore, the image forming apparatus 10 includes functional portions including a control portion 6, a conversion portion 7, and an estimation portion 8, and further includes a storage device 9.

The UI portion 1 provides the user of an interface with the image forming apparatus 10. Specifically, the UI portion 1 receives an instruction from the user and notifies the user of various types of information related to the image forming apparatus 10.

The image forming portion 2 uses an image forming unit to form an image that a piece of print data represents on a recording medium. In the image forming portion 2, an image forming style may be a desired style such as an electro-photographic style, an inkjet style, or an offset printing style.

The reading portion 3 uses a scanner unit to optically read the content of a document. A data format called RAW data represents the content of the document, which the scanner unit has read. A piece of RAW data is a piece of data that the content of a document, which the scanner unit has read, is outputted as is without having undergone a process. That is, a piece of RAW data is a piece of unprocessed data that has undergone no image process and that has not yet been compressed, and is an example of a piece of image data according to the present disclosure.

Note that, as will be described later, a piece of print data and a piece of scan data are pieces of data generated as the piece of RAW data undergoes a conversion process.

The fax processing portion 4 receives a piece of data transmitted to the apparatus itself through, for example, a fax line, and transmits a piece of data to a destination that the user designates.

The communication portion 5 performs data communications with an external device via, for example, the Internet or a local area network (LAN). When the scan data transmission function is executed, the communication portion 5 transmits a piece of scan data to an external device that the user designates.

The control portion 6 controls the other functional portions that the image forming apparatus 10 includes to execute functions that the image forming apparatus 10 includes.

The conversion portion 7 converts a data format of each piece of data. Although the reading portion 3 acquires a piece of RAW data of a document, the piece of RAW data is a piece of unprocessed data that has not yet been compressed, which includes information with no missing part, that is, which fully includes information of the original document acquired when the scanner unit has read the document. That is, the piece of RAW data is not a piece of data optimized for each function. Therefore, when the image forming apparatus 10 attempts to use the piece of RAW data to execute a process for each function, a more period of time is required for the process, compared with a case where a piece of optimized data is used. Then, a data format suitable for a process for each function of the image forming apparatus 10 has been determined in advance.

For example, the print function uses a piece of print data to form an image. The scan data transmission function uses a piece of scan data to perform transmission to an external device that the user designates. Therefore, the conversion portion 7 converts the piece of RAW data into a data format in accordance with each function. Similar to a piece of print data and a piece of scan data, a piece of data acquired by converting a piece of RAW data into a data format in accordance with each function is a piece of data acquired by compressing the piece of RAW data in data size. Therefore, a piece of data acquired by converting a piece of RAW data into a data format in accordance with a function may be collectively referred to as a piece of "compressed data".

Additionally, when a piece of data having undergone conversion is a piece of data in a lossless compression format, the conversion portion 7 is able to decode the piece of data having undergone conversion into the piece of RAW data. The term "decoding" refers to inverse conversion of a piece of data. Decoding a piece of data having undergone conversion into the piece of RAW data allows the conversion portion 7 to reconvert the piece of RAW data into a piece of data in a data format suitable for a process for another function. A piece of print data according to the present disclosure is a piece of data in the lossless compression format.

As described above, the image forming apparatus 10 sometimes reconverts a piece of data converted into a piece of data in a data format suitable for a process for one function into a piece of data in a data format suitable for a process for another function. In this case, the conversion portion 7 does not directly convert the piece of data in the data format suitable for the process for the one function into the piece of data in the data format suitable for the process for the other function, but first decodes the piece of data into the piece of RAW data and then reconverts the piece of RAW data into the piece of data in the data format suitable for the process for the other function. One reason of this action is that, even though there is a piece of data in a data format suitable for a process for a certain function, further storing the piece of RAW data that is a source of conversion of the piece of data reduces a vacant capacity of the storage device 9.

For a document that the reading portion 3 has read, the estimation portion 8 estimates a model volume of a piece of RAW data of one document and a model volume of a piece of print data of the one document. Note that an estimation method for each model volume that the estimation portion 8 performs will be described later.

The storage device 9 stores at least either a piece of RAW data or a piece of data in a data format in accordance with each function. A storage capacity of the storage device 9 varies depending on a model type of the image forming apparatus 10. To achieve a reduction in product cost in a low-end type model type, a storage device 9 that is smaller in storage capacity than a storage device 9 used in a high-end type model type is used. The image forming apparatus 10 according to the present disclosure is also a low-end type model type.

The image forming apparatus 10 having such a functional configuration example as described above is configured by using, for example, a computer 20.

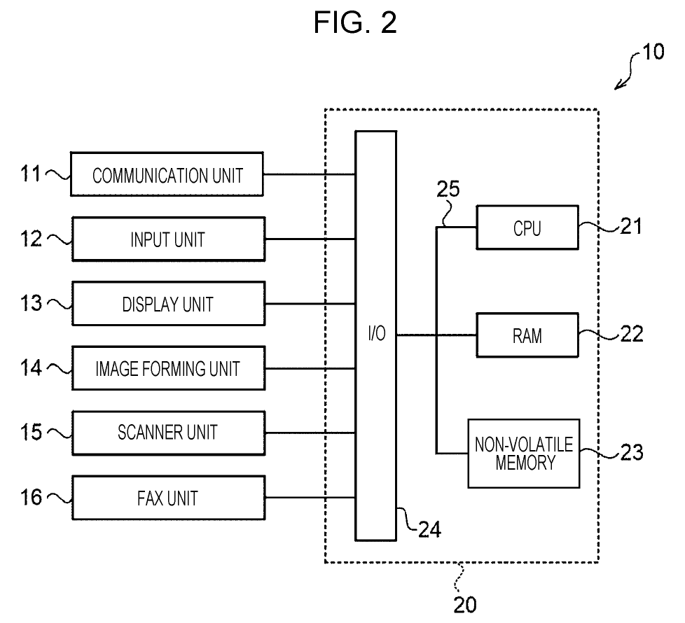

FIG. 2 is a diagram illustrating a configuration example of a main part in an electrical system in the image forming apparatus 10 configured by using the computer 20.

The computer 20 configuring the image forming apparatus 10 includes a central processing unit (CPU) 21 that is an example of a processor executing various types of functional portions. Additionally, the computer 20 further includes a random access memory (RAM) 22 used as a temporary working region for the CPU 21, a non-volatile memory 23, and an input-and-output interface (I/O) 24. The CPU 21, the RAM 22, the non-volatile memory 23, and the I/O 24 are coupled to each other via a bus 25.

The non-volatile memory 23 is an example of a storage device that maintains stored information even when power supplied to the non-volatile memory 23 is interrupted. Although a semiconductor memory is used as the non-volatile memory 23, for example, a hard disk may be used. Information that has to be continuously stored even when power to the image forming apparatus 10 is interrupted is stored in the non-volatile memory 23. Therefore, the non-volatile memory 23 is used as the storage device 9.

For example, a communication unit 11, an input unit 12, a display unit 13, an image forming unit 14, a scanner unit 15, and a fax unit 16 are coupled to the I/O 24.

The communication unit 11 is coupled to the Internet or a local area network (LAN) and has a communication protocol for transmitting and receiving a piece of data to and from an external device.

The input unit 12 is a device that receives an instruction from the user and notifies the CPU 21 of the instruction. The input unit 12 includes, for example, buttons and a touch panel.

The display unit 13 is an example of a display device that displays information that the CPU 21 has processed as an image. The display unit 13 includes, for example, a liquid crystal display or an organic electro-luminescence (EL) display.

The image forming unit 14 follows an instruction provided from the CPU 21 to form an image that a piece of print data represents on a recording medium.

The scanner unit 15 follows an instruction provided from the CPU 21 to optically reads, for example, the content of a document placed on a platen glass and converts the read content of the document into a piece of RAW data. Note that the image forming apparatus 10 may receive a piece of RAW data of a document from an external device via the communication unit 11.

The fax unit 16 is coupled to a fax line and has a communication protocol for transmitting and receiving a piece of data to and from another fax device.

The image forming apparatus 10 according to the present disclosure, which has the functional configuration example illustrated in FIG. 1, supports a multi-job flow. A multi-job flow is a service for performing processes when a plurality of functions are combined with each other with respect to a single input. For example, a process of printing out the content of a document that the reading portion 3 reads and transmitting the content of the document is an example of the multi-job flow. That is, the image forming apparatus 10 may execute, for example, the print process and the scan data transmission process on a document that the reading portion 3 reads.

As described above, how the user behaves when the user has instructed execution of a multi-job flow including the print process will now be studied herein. Note that there is no restriction when the print process and another process are to be combined with each other in a multi-job flow. Hereinafter, as an example, a multi-job flow in which the print process and the scan data transmission process are executed on a document that the scanner unit 15 reads will now be described.

A solo task that the image forming apparatus 10 performs with regard to the scan data transmission process is to transmit a piece of scan data to an external device that the user designates. After the user has caused the scanner unit 15 to read a document, there is no particular task that the user should perform. Therefore, although the user may wait around the image forming apparatus 10 until the scan data transmission process is completed, the user may away from the image forming apparatus 10 before the scan data transmission process is completed.

On the other hand, with regard to the print process, the user has to bring back a copy of the document, which is to be printed out. Therefore, the user has to wait around the image forming apparatus 10 until a copy of the document is printed out.

As described above, processes executed in accordance with a multi-job flow include a process that requires the user to wait and a process that does not require the user to wait. Therefore, if the image forming apparatus 10 performs the print process last, for example, the user is forced to wait around the image forming apparatus 10 until all the processes that the multi-job flow includes have ended. To avoid such a situation, for example, the user may individually designate an order of execution of the processes in the multi-job flow. A high-end type model type may be provided with a designation function of individually designating an order of execution of processes in a multi-job flow as described above. However, since the image forming apparatus 10 is a low-end type model type, such a function of allowing a user to individually designate an order of execution of processes in a multi-job flow is not provided. Since, even when it is such a low-end type model type, processes for a plurality of functions are to be executed in a multi-job flow, the image forming apparatus 10 has been demanded to perform such control of shortening a waiting period of time for the user as much as possible.

A process, when the user executes a multi-job flow including the print process, for reducing a waiting period of time for the user to wait around the image forming apparatus 10 as much as possible will now be studied herein.

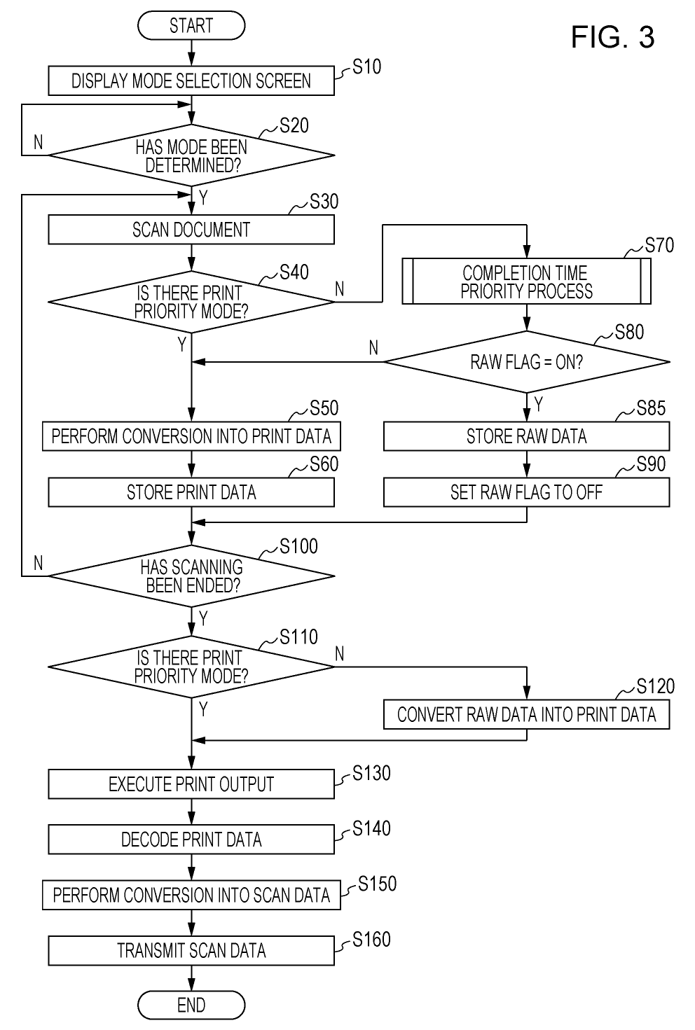

FIG. 3 is a flowchart illustrating an example of a flow of an execution process for a multi-job flow, which the CPU 21 in the image forming apparatus 10 executes when an execution instruction for the multi-job flow including the print process is received from the user.

An information processing program that defines the execution process is stored in advance in, for example, the non-volatile memory 23 in the image forming apparatus 10. The CPU 21 reads the information processing program stored in the non-volatile memory 23 and executes the execution process. Note that, as described above, the execution process will be described with reference to an example of a multi-job flow including the print process and the scan data transmission process. Prior to execution of the execution process, a RAW flag is set to off. The RAW flag is, for example, a flag stored in the RAM 22 and represents a state using one of two values to indicate on or off. A role of the RAW flag will be described later. Additionally, an execution instruction for a multi-job flow includes, for example, information of a number of documents that are subject to the multi-job flow, a number of copies to be printed out, and designation of an external device to which a piece of scan data is to be transmitted. The number of documents that are subject to the multi-job flow is referred to as a "total number of documents".

At step S10 illustrated in FIG. 3, the CPU 21 controls the the display unit 13 and causes the display unit 13 to display a mode selection screen. The mode selection screen is an example of a selection screen according to the present disclosure. The mode selection screen is a screen for prompting the user to select an execution mode for a multi-job flow in the image forming apparatus 10. The execution mode for a multi-job flow includes a print priority mode and a completion time priority mode.

The print priority mode is a mode in which a period of time required for the print process is shortened as much as possible. The print priority mode is an example of a first mode according to the present disclosure.

The completion time priority mode is a mode that aims to shorten a total period of time required from start to end of a multi-job flow, compared with the period of time taken in the print priority mode. The completion time priority mode is an example of a second mode according to the present disclosure. The user selects a desired mode from the mode selection screen.

Although selection of a desired mode is possible, the user is not allowed to individually designate an order of execution of processes in a multi-job flow to be executed in each mode. The CPU 21 determines the order of execution of the processes in each mode.

At step S20, the CPU 21 determines whether or not the user has selected a desired mode on the mode selection screen and has determined the mode. When no mode has been determined, the determination process at step S20 is repeatedly executed, and a situation where the user selects a mode is monitored. When the mode has been determined, the processing proceeds to step S30.

At step S30, the CPU 21 controls the scanner unit 15 to read a document placed on the scanner unit 15. With this process, a piece of RAW data of the document is acquired. The piece of RAW data of the document that the scanner unit 15 has read is stored in the RAM 22. Note that an action that the scanner unit 15 reads a document may be referred to as "scanning".

At step S40, the CPU 21 determines whether or not the mode that the user has selected is the print priority mode. When the selected mode is the print priority mode, the processing proceeds to step S50.

At step S50, the CPU 21 converts the piece of RAW data of the document, which has been acquired at step S30, into a piece of print data. To increase a vacant capacity of the RAM 22, the CPU 21 deletes the piece of RAW data that has been converted into the piece of print data from the RAM 22.

At step S60, the CPU 21 causes the non-volatile memory 23 to store the piece of print data of the document, which has been acquired at step S50.

At step S100, the CPU 21 determines whether or not all documents have been placed on the scanner unit 15 and have been scanned. When there is still a document that has not been scanned, the processing proceeds to step S30. That is, when the user has selected the print priority mode, pieces of RAW data of all documents are converted into pieces of print data and the the pieces of print data are stored in the non-volatile memory 23. When all the documents have been scanned, the processing proceeds to step S110.

At step S110, the CPU 21 determines whether or not the mode that the user has selected is the print priority mode. When the selected mode is the print priority mode, the processing proceeds to step S130.

At step S130, the CPU 21 sequentially outputs the pieces of print data stored in the non-volatile memory 23 to the image forming unit 14 at the number of copies that the user has designated. Thereby, print out of the documents is executed in line with the designated number of copies.

Next, the CPU 21 executes the scan data transmission process that is an example of another process according to the present disclosure. To execute the scan data transmission process, a piece of scan data of a document is required. When the user has selected the print priority mode, however, the pieces of data representing all the documents have been stored as the pieces of print data in the non-volatile memory 23. Additionally, even when the user has selected the completion time priority mode, as will be described later, there are documents stored as pieces of print data in the non-volatile memory 23.

At step S140, the CPU 21 decodes all the pieces of print data stored in the non-volatile memory 23 and inversely convert the decoded pieces of print data into the pieces of RAW data. The CPU 21 causes the RAM 22 to store the inversely converted pieces of RAW data. To increase a vacant capacity of the non-volatile memory 23, the CPU 21 deletes the pieces of print data that have been inversely converted into the pieces of RAW data from the non-volatile memory 23.

At step S150, the CPU 21 converts the pieces of RAW data of all the documents into pieces of scan data. The CPU 21 stores the converted pieces of scan data in the non-volatile memory 23. To increase the vacant capacity of the RAM 22, the CPU 21 deletes the pieces of RAW data that have been converted into the pieces of scan data from the RAM 22.

At step S160, the CPU 21 controls the communication unit 11 to transmit the pieces of scan data of all the documents, which have been stored in the non-volatile memory 23, to an external device that the user designates. As described above, the execution process for the multi-job flow in the print priority mode ends.

As described above, the print process is executed before another process (the scan data transmission process in the example described above) included in the multi-job flow in the print priority mode. If the print process is executed after the scan data transmission process, the user has to wait around the image forming apparatus 10 until the scan data transmission process and the print process have ended. Executing the print process before the scan data transmission process reduces a waiting period of time for the user, compared with a case where the print process is executed last in a multi-job flow.

In addition, pieces of data representing all documents are stored as pieces of print data in the non-volatile memory 23 in the print priority mode. Therefore, as long as the number of documents is fixed, a size of pieces of data of all documents, which are to be stored in the non-volatile memory 23, is reduced, compared with a case where pieces of data representing all documents are stored as pieces of RAW data in the non-volatile memory 23. On the other hand, the storage capacity of the non-volatile memory 23 is determined in advance. Therefore, it can also be said that it is possible to support a multi-job flow using much more documents in the print priority mode, compared with a case where a piece of data representing a document is stored as a piece of RAW data in the non-volatile memory 23.

Additionally, when the print process is executed after the scan data transmission process, there will be a required period of time for converting a piece of scan data into a piece of print data. Since a piece of RAW data of a document is first converted into a piece of print data in the print priority mode, a process of converting a piece of scan data into a piece of print data becomes unnecessary. Therefore, a required period of time for the print process itself is also reduced, compared with a case where the print process is executed after the scan data transmission process.

On the other hand, when it has been determined in the determination process at step S40 that the selected mode is the completion time priority mode, the processing proceeds to step S70.

At step S70, the CPU 21 executes a completion time priority process. In the print priority mode, pieces of RAW data of all documents are converted into pieces of print data. In the completion time priority process, a data format of a document, which is to be stored in the non-volatile memory 23, is changed in accordance with a remaining capacity of the non-volatile memory 23.

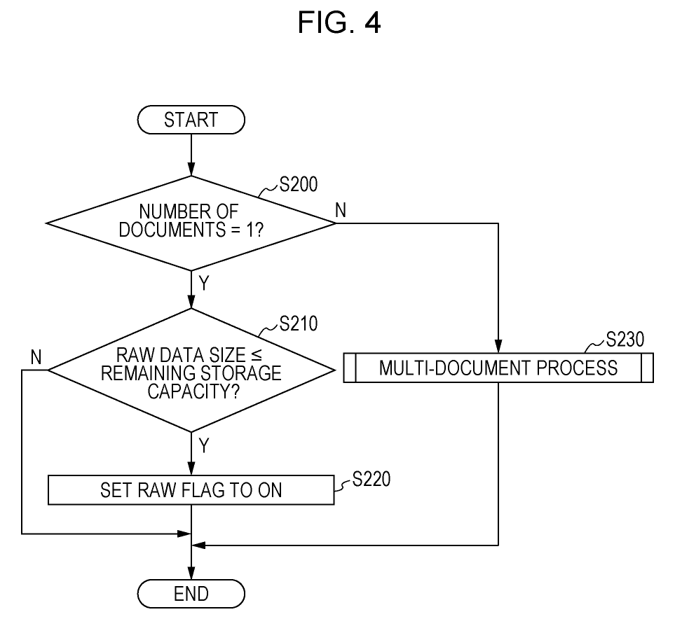

FIG. 4 is a flowchart illustrating an example of a flow of the completion time priority process. At step S200 illustrated in FIG. 4, the CPU 21 determines whether or not the total number of documents is one. When the total number of documents is one, it is possible in many cases to store the document as a piece of RAW data in the non-volatile memory 23, even when the storage capacity of the non-volatile memory 23 is less than a storage capacity in a case of a high-end type model type. Therefore, the processing proceeds to step S210.

At step S210, the CPU 21 determines whether or not a RAW data size representing a volume of the piece of RAW data of the document is equal to or less than the remaining capacity of the non-volatile memory 23. For convenience of explanation, the remaining capacity of the non-volatile memory 23 will be hereinafter referred to as a "remaining storage capacity". When the RAW data size of the document is equal to or less than the remaining storage capacity, the processing proceeds to step S220.

In this case, it is possible to store the document as the piece of RAW data in the non-volatile memory 23. Therefore, at step S220, the CPU 21 sets the RAW flag to on and ends the completion time priority process illustrated in FIG. 4.

The RAW flag that has been set to on indicates that a document is to be stored as a piece of RAW data in the non-volatile memory 23. On the other hand, the RAW flag that has been set to off indicates that a piece of RAW data of a document is to be converted into a piece of print data and the piece of print data is to be stored in the non-volatile memory 23.

When it has been determined in the determination process at step S210 that the RAW data size of the document is greater than the remaining storage capacity, the CPU 21 is not able to cause the non-volatile memory 23 to store the document as the piece of RAW data. Therefore, the CPU 21 does not execute step S220, that is, causes the RAW flag that has been set to off to remain unchanged and ends the completion time priority process illustrated in FIG. 4.

On the other hand, when it has been determined in the determination process at step S200 that the total number of documents is two or more, the processing proceeds to step S230.

At step S230, the CPU 21 executes a multi-document process. In the multi-document process, an adjustment in number for documents to be stored as pieces of RAW data is performed for all the documents to allow, under a condition that either pieces of RAW data or pieces of print data are to be stored in the non-volatile memory 23, the documents to be stored as many as possible as pieces of RAW data. Therefore, as will be described later, the value of the RAW flag is set for each of the documents, which has been scanned at step S30 illustrated in FIG. 3, in the multi-document process. As the multi-document process ends, the completion time priority process illustrated in FIG. 4 ends.

As the completion time priority process ends, the processing proceeds to step S80 illustrated in FIG. 3. At step S80, the CPU 21 determines whether or not the RAW flag has been set to on. When the RAW flag has not yet been set to on, that is, when the RAW flag has been set to off, the processing proceeds to step S50. Therefore, the piece of RAW data of the document scanned at step S30 is converted into a piece of print data. On the other hand, when it has been determined in the determination process at step S80 that the RAW flag has been set to on, the processing proceeds to step S85.

At step S85, the CPU 21 does not convert the document scanned at step S30 into a piece of print data but causes the non-volatile memory 23 to store the document as the piece of RAW data. It has been confirmed that it is possible to store a document with the RAW flag set to on as a piece of RAW data in the non-volatile memory 23 through the completion time priority process.

At step S90, the CPU 21 sets the RAW flag to off in preparation for scanning of a next one of the documents, and the processing proceeds to step S100.

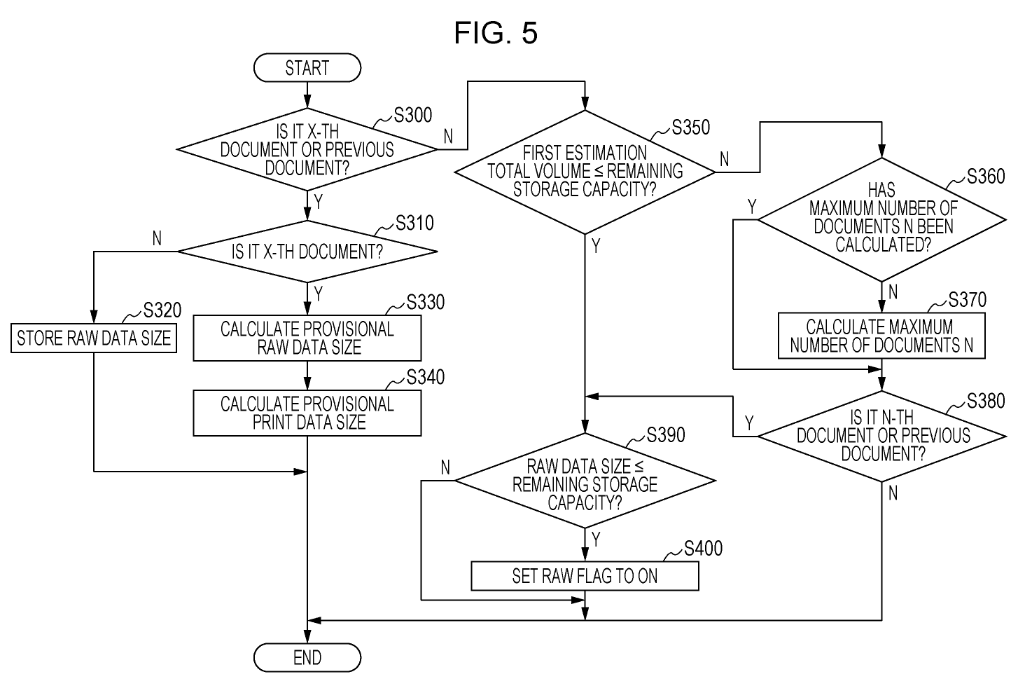

FIG. 5 is a flowchart illustrating an example of a flow of the multi-document process at step S230 illustrated in FIG. 4. At step S300 illustrated in FIG. 5, the CPU 21 determines whether or not the document scanned at step S30 illustrated in FIG. 3 is an X-th document or a previous document. In here, X defines the number of documents that undergo scanning and is an integer of 2 or greater. The number of documents X is an example of a designated number of documents according to the present disclosure and is, for example, a value that the user sets in advance. The number of documents X is a changeable value and is stored in the non-volatile memory 23. When the document having undergone scanning is a document among a first document to the X-th document, the processing proceeds to step S310.

At step S310, the CPU 21 determines whether or not the document scanned at step S30 illustrated in FIG. 3 is the X-th document. When the scanned document is a document among the first document to an (X-1)-th document, the processing proceeds to step S320.

At step S320, the CPU 21 causes the RAM 22 to store the RAW data size of the document having undergone scanning, and ends the multi-document process illustrated in FIG. 5. In this case, the RAW flag is set to off. Therefore, the first document to the (X-1)-th document are to be converted into the pieces of print data and the pieces of print data are to be stored in the non-volatile memory 23 at step S50 and step S60 illustrated in FIG. 3.

On the other hand, when it has been determined in the determination process at step S310 that the document scanned at step S30 illustrated in FIG. 3 is the X-th document, the processing proceeds to step S330.

At step S330, the CPU 21 uses the RAW data sizes of the first document to the X-th document to calculate a provisional RAW data size. The provisional RAW data size refers to an estimation model volume of a piece of RAW data of one document that the scanner unit 15 reads. Specifically, the CPU 21 sets an average of the RAW data sizes of the first document to the X-th document as a provisional RAW data size. The CPU 21 calculates a provisional RAW data size to estimate the RAW data size of each document subsequent to the X-th document. Note that the RAM 22 has stored at step S320 the RAW data sizes of the first document to the (X-1)-th document. The RAW data size of the X-th document is acquired from the piece of RAW data of the X-th document, which has been stored in the RAM 22 at step S30 illustrated in FIG. 3. The provisional RAW data size is an example of a first model volume according to the present disclosure.

At step S340, the CPU 21 uses the print data sizes of the first document to the X-th document to calculate a provisional print data size. The provisional print data size is an estimation model volume of a piece of print data of one document that the scanner unit 15 reads. Specifically, the CPU 21 sets an average of the print data sizes of the first document to the X-th document as the provisional print data size. The CPU 21 calculates the provisional print data size to estimate a print data size of each document subsequent to the X-th document. The print data sizes of the first document to the (X-1)-th document are acquired from the pieces of print data of the documents stored in the non-volatile memory 23 at step S60 illustrated in FIG. 3. The print data size of the X-th document is acquired as the CPU 21 converts the piece of RAW data of the X-th document into a piece of print data. To calculate a provisional print data size, the CPU 21 converts at step S340 the piece of RAW data of the X-th document into a piece of print data. Therefore, for the X-th document, a process of converting the piece of RAW data of the X-th document into a piece of print data at step S50 illustrated in FIG. 3 becomes unnecessary. Note that, after the X-th document has been converted into a piece of print data, the CPU 21 deletes the piece of RAW data of the X-th document from the RAM 22, similar or identical to the process at step S50. The provisional print data size is an example of a second model volume according to the present disclosure.

After the provisional print data size has been calculated at step S340, the CPU 21 ends the multi-document process illustrated in FIG. 5. In this case, the RAW flag is set to off. Therefore, at step S50 and step S60 illustrated in FIG. 3, similar or identical to the first document to the (X-1)-th document, the X-th document is also converted into a piece of print data and the piece of print data is stored in the non-volatile memory 23.

That is, when the completion time priority mode has been selected in a situation where there are a plurality of documents to be read, the CPU 21 uses the first document to the X-th document to calculate a provisional RAW data size and a provisional print data size. Additionally, the CPU 21 converts the first document to the X-th document each into a data format suitable for the print process and stores the converted ones in the non-volatile memory 23.

As will be described below, the CPU 21 determines a data format for a piece pf data representing each of remaining documents based on the provisional RAW data size, the provisional print data size, the remaining storage capacity, and the number of the remaining documents. Note that the remaining documents refer to documents among the documents each placed on the scanner unit 15, for which pieces of data representing the documents have not yet been stored in the non-volatile memory 23. The number of the remaining documents is the number of the rest of the documents.

When it has been determined in the determination process at step S300 that the document having undergone scanning is a document after the X-th document, the processing proceeds to step S350.

At step S350, the CPU 21 determines whether or not a first estimation total volume is equal to or less than the remaining storage capacity. The first estimation total volume is a data volume required for the non-volatile memory 23 when all remaining documents are to be stored as pieces of RAW data in the non-volatile memory 23. That is, the first estimation total volume is also an estimation total volume of pieces of RAW data corresponding to all remaining documents. The first estimation total volume is represented by a product of the provisional RAW data size and the number of remaining documents.

When the first estimation total volume is equal to or less than the remaining storage capacity, it is possible to store all remaining documents as pieces of RAW data in the non-volatile memory 23.

As described above so far, the image forming apparatus 10 that supports a multi-job flow converts, for each function to be executed, a piece of RAW data into a data format in accordance with the function to be executed. In conversion of data format, a more period of time for conversion is required in a case where a piece of compressed data is decoded into a piece of RAW data than a case where a piece of RAW data is converted into a piece of compressed data, since a more amount of calculation is required. Therefore, to minimize a period of time required for the conversion process in data format, a document is preferably stored as a piece of RAW data in the non-volatile memory 23.

However, even when the first estimation total volume is equal to or less than the remaining storage capacity, it is not necessarily that it is possible to store all remaining documents as pieces of RAW data in the non-volatile memory 23. One reason of this issue is that the provisional RAW data size is a mere average of the RAW data sizes, which corresponds to one document, among the first document to the X-th document. It is not always guaranteed that a total of the RAW data sizes of remaining documents coincides with the provisional RAW data size. That is, even when the first estimation total volume is equal to or less than the remaining storage capacity, there may be an actual case where the remaining storage capacity is insufficient to store each document as a piece of RAW data in the non-volatile memory 23.

Therefore, the CPU 21 determines at step S390 whether or not the RAW data size of the document having undergone scanning at step S30 illustrated in FIG. 3 is equal to or less than the remaining storage capacity. When the RAW data size of the document is equal to or less than the remaining storage capacity, the processing proceeds to step S400.

In this case, it is possible to store the document as a piece of RAW data in the non-volatile memory 23. Therefore, the CPU 21 sets at step S400 the RAW flag to on and ends the multi-document process illustrated in FIG. 5.

When it has been determined in the determination process at step S390 that the RAW data size of the document is greater than the remaining storage capacity, the CPU 21 does not set the RAW flag to on but ends the multi-document process illustrated in FIG. 5. In this case, the piece of RAW data of the document is converted into a piece of print data and the piece of print data is stored in the non-volatile memory 23 at step S50 and step S60 illustrated in FIG. 3.

On the other hand, when it has been determined in the determination process at step S350 that the first estimation total volume is greater than the remaining storage capacity, the processing proceeds to step S360. In this case, it is estimated that it is impossible to store all remaining documents as pieces of RAW data in the non-volatile memory 23. Therefore, at step S360, the CPU 21 determines whether or not a maximum number of documents N (N is an integer of 0 or greater) has been calculated. The maximum number of documents N represents a maximum number of documents that the non-volatile memory 23 is able to store as pieces of RAW data, under a condition that, among remaining documents, pieces of data representing all the remaining documents are to be stored in the non-volatile memory 23 in any data format. When the maximum number of documents N has not yet been calculated, the processing proceeds to step S370.

At step S370, the CPU 21 calculates the maximum number of documents N, and the processing proceeds to step S380. It is assumed that the provisional RAW data size is represented by "RAW", the provisional print data size is represented by "PRN", the number of remaining documents is represented by "W", and, among the remaining documents, the number of documents to be converted into pieces of print data and stored is represented by "Y". Additionally, the remaining storage capacity is represented by "MEM". In this case, when (RAW x N + PRN x Y) ≤ MEM, it is possible to store each of the remaining documents in the non-volatile memory 23 in a data format of either a piece of RAW data or a piece of print data. Therefore, it is sufficient that the CPU 21 calculates a value that maximizes (MEM - PRN x Y) / RAW as the maximum number of documents N. To make the maximum number of documents N into an integer, the CPU 21 rounds down those after a decimal point of the maximum number of documents N.

On the other hand, when the maximum number of documents N has been calculated, the processing skips step S370 but proceeds to step S380.

At step S380, the CPU 21 determines whether or not it is an N-th document or a previous document. The N-th document or a previous document refers to a document that is the N-th or a previous place counted from a document next to the X-th document. When an immediately-previously scanned document at step S30 illustrated in FIG. 3 is the N-th document or a previous document, it may be possible to store the document in the format of a piece of RAW data in the non-volatile memory 23. Therefore, the processing proceeds to step S390. Those at step S390 and subsequent steps in the processing have already been described above.

On the other hand, when it has been determined in the determination process at step S380 that it is not the N-th document or a previous document, the CPU 21 does not set the RAW flag to on but ends the multi-document process illustrated in FIG. 5. In this case, the piece of RAW data of the document is converted into a piece of print data and the piece of print data is stored in the non-volatile memory 23 at step S50 and step S60 illustrated in FIG. 3.

As described above, for the X-th document or a previous document, in the completion time priority mode, the CPU 21 converts a piece of data representing the document into a piece of print data and causes the non-volatile memory 23 to store the piece of print data. Additionally, for a document after the X-th document, in the completion time priority mode, the CPU 21 changes the data format of the document, which is to be stored in the non-volatile memory 23, depending on a magnitude relationship between the first estimation total volume and the remaining storage capacity.

When it has been determined at step S110 illustrated in FIG. 3 that the selected mode is not the print priority mode, that is, when it has been determined that the selected mode is the completion time priority mode, the processing proceeds to step S120.

At step S120, the CPU 21 converts the document stored in the non-volatile memory 23 as the piece of RAW data into a piece of print data, and the processing proceeds to step S130. The converted piece of print data is stored in the RAM 22. Those at step S130 and subsequent steps in the processing have already been described above.

As described above, the execution process for the multi-job flow illustrated in FIG. 3 ends.

As described above, the print process is executed before another process (the scan data transmission process in the example described above) included in the multi-job flow even in the completion time priority mode.

Additionally, as described above, a more period of time for conversion is required in a case where a piece of compressed data is decoded into a piece of RAW data than a case where a piece of RAW data is converted into a piece of compressed data. In the completion time priority mode, a piece of data representing a document is stored as a piece of RAW data as much as possible in the non-volatile memory 23. Therefore, when the scan data transmission process is executed after the print process is executed, it is possible to convert a document for which a piece of RAW data is stored from the piece of RAW data into a piece of scan data. That is, in the completion time priority mode, documents for which pieces of print data are decoded into pieces of RAW data and then the pieces of RAW data are converted into pieces of scan data are reduced in number, compared with that in the print priority mode. Therefore, in the completion time priority mode, a total period of time required from the start to the end of a multi-job flow may become shorter than that in the print priority mode.

On the other hand, in the print priority mode, pieces of data representing documents are all converted into pieces of print data and the pieces of print data are stored in the non-volatile memory 23. On the other hand, in the completion time priority mode, there is also a document stored as a pieces of RAW data in the non-volatile memory 23. Therefore, similar or identical to step S120 illustrated in FIG. 3, the piece of RAW data is converted into a piece of print data before the document is printed out. Therefore, a processing period of time required from the start to the end of the print process may become shorter in the print priority mode than that in the completion time priority mode.

From those described above, a user who, when a document is printed out, brings back a copy of the document without waiting for completion of another process may preferably select the print priority mode. On the other hand, a user who confirms the completion of a multi-job flow and then moves away from the image forming apparatus 10 may preferably select the completion time priority mode.

Note that, instead of the user, the CPU 21 may set the number of documents X used in the determination process at step S300 illustrated in FIG. 5 in accordance with a total number of documents.

An execution instruction for a multi-job flow includes a total number of documents. Therefore, the CPU 21 may set, for example, a number of documents corresponding to 10% of a total number of documents as the number of documents X. As the total number of documents changes, the number of documents X also changes. Obviously, a ratio (hereinafter referred to as a "setting ratio") of a total number of documents, which is used to set the number of documents X, such as 10%, is a mere example, and a value other than 10% may be used.

Note that, when the setting ratio is a fixed value, the number of documents X increases as a total number of documents increases. In the completion time priority mode, the first document to the X-th document are converted into pieces of print data. Therefore, as a total number of documents increases, a number of documents to be stored in the data format of pieces of print data also increases. As a number of documents to be stored in the data format of print data increases, a total period of time taken for a multi-job flow also increases. Therefore, the CPU 21 may set, when a total number of documents is equal to or greater than a predetermined threshold value, the number X to the threshold value to set an upper limit for the number of documents X.

Additionally, instead of setting an upper limit for the number of documents X, the CPU 21 may lower a setting ratio as a total number of documents increases. For example, when a total number of documents is equal to or greater than 20 and less than 40, the setting ratio is set to 20%, and, when a total number of documents is equal to or greater than 40 and less than 60, the setting ratio is lowered to 15%.

While an aspect of the image forming apparatus 10 have been described above with reference to the exemplary embodiment, the disclosed form of the image forming apparatus 10 is a mere example. The form of the image forming apparatus 10 is not limited to fall within the scope described in the exemplary embodiment. It is possible to apply various modifications or improvements to the exemplary embodiment without departing from the spirit of the present disclosure. A form to which one of the various modifications or improvements described above is added also falls within the technical scope of the present disclosure. For example, the processing order in the processes illustrated in FIG. 3 to FIG. 5 may be changed without departing from the scope of the present disclosure.

Additionally, in the exemplary embodiment described above, a form where the execution process for a multi-job flow is achieved in a form of software has been described as an example. However, those equivalent to the processes illustrated in the flowcharts may be executed in the form of hardware. In this case, it is possible to increase a speed of executing processes, compared with a case where an execution process for a multi-job flow is achieved in the form of software.

In the present exemplary embodiment, a desired computer executes each of the processes. Additionally, the desired computer may use one or a combination of a processor in the form of hardware and a program in the form of software to execute these processes. In that case, the processor is configured to cooperate with the program to execute various processes according to the exemplary embodiment, and, in addition, to function as each unit or each means according to the exemplary embodiment. Additionally, an order according to which the processor executes the processes is not limited to the order described above, and may be changed appropriately. The desired computer may be a general-purpose computer, a special-purpose computer, a workstation, or another system capable of executing each of the processes.

The processor may be configured to include one piece or a plurality of pieces of hardware, and the hardware is not limited in type. For example, the processor may be configured to include a programmable logic device such as a CPU, a micro processing unit (MPU), or a field programmable gate array (FPGA), a dedicated circuit for executing a specific process such as an application specific integrated circuit (ASIC), or hardware such as a graphic processing unit (GPU) or a neural processing unit (NPU). Additionally, for the type of hardware, different types of hardware may be combined. When pieces of hardware are configured to execute one or more processes of a certain processor, the pieces of hardware may be present in devices physically separated from each other or may be present in a single device. Additionally, in the exemplary embodiment, the order according to which the processor executes the processes is not limited to the order described above and may be changed appropriately. Note that the hardware is configured to include electric circuitry in which circuit elements such as semiconductor devices are combined, for example.

Furthermore, the program may be firmware or software such as a microcode. Additionally, the program may be, for example, a program module group, and its functions may be implemented by processors configured to implement the respective functions. The program may be program code or a plurality of code segments stored in one or a plurality of non-transitory computer readable media (for example, a storage medium or another storage). The program may be stored in such a divided manner in a plurality of non-transitory computer readable media that are present in apparatuses physically away from each other. The program code or the code segments may represent a procedure, a function, a sub program, a routine, a subroutine, a module, a software package, a class, or any combination of instructions, data structures, or program statements. The program code or the code segments may be coupled to another code segment or a hardware circuit through transmission and/or reception of information, data, an argument, a parameter, or a piece of content in a memory. Additionally, the program according to the present application may be provided as a program product.

Furthermore, the image forming apparatus 10 may download the information processing program from an external device through the communication unit 11 and store the downloaded information processing program in the non-volatile memory 23.

### Appendix

### (((1)))

An information processing system comprising a processor configured to execute, when a plurality of processes including a print process are to be executed on a recording medium by using image data that is unprocessed data that has not yet undergone an image process and has not yet been compressed and when the plurality of processes are to be executed with no order of execution individually designated, the print process before the other processes.

### (((2)))

The information processing system according to (((1))), wherein the processor is configured to: display a selection screen for prompting a user to select and apply either a first mode in which the print process is executed before the other processes or a second mode in which a required period of time for completing the plurality of processes is shorter than the required period of time taken in the first mode; and execute, when the user has selected the first mode, the print process before the other processes.

### (((3)))

The information processing system according to (((2))), wherein the processor is configured to convert, when the user has selected the first mode, the image data into print data in a predetermined lossless compression format, store the print data in a storage device, and execute the print process by using the print data stored in the storage device.

### (((4)))

The information processing system according to (((3))), wherein the processor is configured to inversely convert the print data into the unprocessed data representing an original data format of the image data, convert the inversely converted image data into process data having a predetermined format in accordance with another one of the processes, the other one having not yet undergone execution, and execute the other one of the processes by using the process data.

### (((5)))

The information processing system according to (((2))), wherein the processor is configured to change, when the user has selected the second mode, a data format of the image data to be stored in the storage device in accordance with a remaining capacity of the storage device that stores data.

### (((6)))

The information processing system according to (((5))), wherein the processor is configured to store, when the image data represents one document and a volume of the image data representing the one document is equal to or less than the remaining capacity of the storage device, the image data representing the one document in the storage device.

### (((7)))

The information processing system according to (((5))), wherein the processor is configured to convert, when the image data represents one document and a volume of the image data representing the one document is greater than the remaining capacity of the storage device, the image data representing the one document into print data in a predetermined lossless compression format and store the print data in the storage device.

### (((8)))

The information processing system according to (((5))), wherein the processor is configured to: convert, when the image data represents a plurality of documents, a piece of the image data, the piece corresponding to each of some of the documents, the some corresponding to a designated number of documents counted from a first one, into a piece of print data in a predetermined lossless compression format and store the piece of print data in the storage device and estimate, by using the pieces of the image data, the pieces representing the designated number of documents, a first model volume that is an estimation model volume of another piece of the image data, the other piece corresponding to one of remaining some of the documents, and a second model volume that is, after the other piece of the image data is converted into another piece of print data in the predetermined lossless compression format, an estimation model volume of the other piece of print data, the other piece corresponding to the one of the remaining some of the documents; and change the data format of the other piece of image data to be stored in the storage device depending on the first model volume and a magnitude relationship between a first estimation total volume that is a volume acquired from the remaining some of the documents, for which corresponding pieces of the image data have not yet been stored in the storage device, and that is an estimation total volume of the corresponding pieces of the image data of all the remaining some of the documents and the remaining capacity of the storage device.

### (((9)))

The information processing system according to (((8))), wherein the processor is configured to store, when the first estimation total volume is equal to or less than the remaining capacity of the storage device, in the storage device, each of the pieces of the image data, the pieces representing the remaining some of the documents, with the data format of each of the pieces of the image data unconverted.

### (((10)))

The information processing system according to (((8))), wherein the processor is configured to calculate, when the first estimation total volume is greater than the remaining capacity of the storage device, under a condition that pieces of data representing all the remaining some of the documents are to be stored in the storage device, a maximum number of documents storable in the storage device with the data format of each of the pieces of image data unconverted, among the remaining some of the documents, store each of corresponding pieces of the image data of the maximum number of documents in the storage device with the data format unconverted, convert still remaining some of the documents, other than the documents stored in the storage device with the data format of each of the pieces of image data unconverted, among the remaining some of the documents, a piece of the image data, the piece representing each of the still remaining some of the documents, into the piece of print data, and stores the piece of print data in the storage device.

### (((11)))

The information processing system according to (((9))) or (((10))), wherein the processor is configured to store, when a volume of one of the pieces of image data to be stored in the storage device is equal to or less than the remaining capacity of the storage device, the one of the pieces of image data in the storage device.

### (((12)))

The information processing system according to (((9))) or (((10))), wherein the processor is configured to convert, when a volume of one of the pieces of image data to be stored in the storage device is greater than the remaining capacity of the storage device, the one of the pieces of image data into the piece of print data and stores the piece of print data in the storage device.

### (((13)))

The information processing system according to any one of (((8))) to (((12))), wherein the processor is configured to change the designated number of documents in accordance with a number of documents that the pieces of image data represent.

### (((14)))

A program causing a computer to execute a process for information processing, the process comprising executing, when a plurality of processes including a print process are to be executed on a recording medium by using image data that is unprocessed data that has not yet undergone an image process and has not yet been compressed and when the plurality of processes are to be executed with no order of execution individually designated, the print process before the other processes.

What is claimed is:

1. An information processing system comprising:
a processor configured to execute, when a plurality of processes including a print process are to be executed on a recording medium by using image data that is unprocessed data that has not yet undergone an image process and has not yet been compressed and when the plurality of processes are to be executed with no order of execution individually designated, the print process before the other processes.

2. The information processing system according to claim 1, wherein the processor is configured to:
display a selection screen for prompting a user to select and apply either a first mode in which the print process is executed before the other processes or a second mode in which a required period of time for completing the plurality of processes is shorter than the required period of time taken in the first mode; and
execute, when the user has selected the first mode, the print process before the other processes.

3. The information processing system according to claim 2, wherein the processor is configured to convert, when the user has selected the first mode, the image data into print data in a predetermined lossless compression format, store the print data in a storage device, and execute the print process by using the print data stored in the storage device.

4. The information processing system according to claim 3, wherein the processor is configured to inversely convert the print data into the unprocessed data representing an original data format of the image data, convert the inversely converted image data into process data having a predetermined format in accordance with another one of the processes, the other one having not yet undergone execution, and execute the other one of the processes by using the process data.

5. The information processing system according to claim 2, wherein the processor is configured to change, when the user has selected the second mode, a data format of the image data to be stored in the storage device in accordance with a remaining capacity of the storage device that stores data.

6. The information processing system according to claim 5, wherein the processor is configured to store, when the image data represents one document and a volume of the image data representing the one document is equal to or less than the remaining capacity of the storage device, the image data representing the one document in the storage device.

7. The information processing system according to claim 5, wherein the processor is configured to convert, when the image data represents one document and a volume of the image data representing the one document is greater than the remaining capacity of the storage device, the image data representing the one document into print data in a predetermined lossless compression format and store the print data in the storage device.

8. The information processing system according to claim 5, wherein the processor is configured to:
convert, when the image data represents a plurality of documents, a piece of the image data, the piece corresponding to each of some of the documents, the some corresponding to a designated number of documents counted from a first one, into a piece of print data in a predetermined lossless compression format and store the piece of print data in the storage device and estimate, by using the pieces of the image data, the pieces representing the designated number of documents, a first model volume that is an estimation model volume of another piece of the image data, the other piece corresponding to one of remaining some of the documents, and a second model volume that is, after the other piece of the image data is converted into another piece of print data in the predetermined lossless compression format, an estimation model volume of the other piece of print data, the other piece corresponding to the one of the remaining some of the documents; and
change the data format of the other piece of image data to be stored in the storage device depending on the first model volume and a magnitude relationship between a first estimation total volume that is a volume acquired from the remaining some of the documents, for which corresponding pieces of the image data have not yet been stored in the storage device, and that is an estimation total volume of the corresponding pieces of the image data of all the remaining some of the documents and the remaining capacity of the storage device.

9. The information processing system according to claim 8, wherein the processor is configured to store, when the first estimation total volume is equal to or less than the remaining capacity of the storage device, in the storage device, each of the pieces of the image data, the pieces representing the remaining some of the documents, with the data format of each of the pieces of the image data unconverted.

10. The information processing system according to claim 8, wherein the processor is configured to calculate, when the first estimation total volume is greater than the remaining capacity of the storage device, under a condition that pieces of data representing all the remaining some of the documents are to be stored in the storage device, a maximum number of documents storable in the storage device with the data format of each of the pieces of image data unconverted, among the remaining some of the documents, store each of corresponding pieces of the image data of the maximum number of documents in the storage device with the data format unconverted, convert still remaining some of the documents, other than the documents stored in the storage device with the data format of each of the pieces of image data unconverted, among the remaining some of the documents, a piece of the image data, the piece representing each of the still remaining some of the documents, into the piece of print data, and stores the piece of print data in the storage device.

11. The information processing system according to claim 9, wherein the processor is configured to store, when a volume of one of the pieces of image data to be stored in the storage device is equal to or less than the remaining capacity of the storage device, the one of the pieces of image data in the storage device.

12. The information processing system according to claim 10, wherein the processor is configured to store, when a volume of one of the pieces of image data to be stored in the storage device is equal to or less than the remaining capacity of the storage device, the one of the pieces of image data in the storage device.

13. The information processing system according to claim 9, wherein the processor is configured to convert, when a volume of one of the pieces of image data to be stored in the storage device is greater than the remaining capacity of the storage device, the one of the pieces of image data into the piece of print data and stores the piece of print data in the storage device.

14. The information processing system according to claim 10, wherein the processor is configured to convert, when a volume of one of the pieces of image data to be stored in the storage device is greater than the remaining capacity of the storage device, the one of the pieces of image data into the piece of print data and stores the piece of print data in the storage device.

15. The information processing system according to claim 8, wherein the processor is configured to change the designated number of documents in accordance with a number of documents that the pieces of image data represent.

16. The information processing system according to claim 9, wherein the processor is configured to change the designated number of documents in accordance with a number of documents that the pieces of image data represent.

17. The information processing system according to claim 10, wherein the processor is configured to change the designated number of documents in accordance with a number of documents that the pieces of image data represent.

18. A non-transitory computer readable medium storing a program causing a computer to execute a process for information processing, the process comprising executing, when a plurality of processes including a print process are to be executed on a recording medium by using image data that is unprocessed data that has not yet undergone an image process and has not yet been compressed and when the plurality of processes are to be executed with no order of execution individually designated, the print process before the other processes.
